(19) United States
(12) Patent Application Publication
(10) Pub. No.: US 2012/0169748 A1
(43) Pub. Date: Jul. 5, 2012

(54) DISTRIBUTED GRAPHICS ENGINE

(75) Inventors: David J. MERRILL, San Francisco, CA (US); Jeevan J. KALANITHI, San Francisco, CA (US); Micah SCOTT, San Francisco, CA (US)

(73) Assignee: SIFTEO INC., San Francisco, CA (US)

(21) Appl. No.: 13/341,780

(22) Filed: Dec. 30, 2011

Related U.S. Application Data
(60) Provisional application No. 61/429,373, filed on Jan. 3, 2011.

(51) Int. Cl. G06T 1/00

(52) U.S. Cl. 345/522

(57) ABSTRACT

A distributed graphic engine comprising preloaded graphical data and preloaded graphical instructions are stored on one or more thin client devices. A host or server computer initiates commands which triggers the rendering of graphics on the one or more client devices using preloaded data. As a graphical images are rendered on the client the host can continue to issue commands for the rendering of graphics or or supplement the data and or instructions so as minimize bandwidth and processing requirements.

### RELATED APPLICATION

The present application relates to and claims the benefit of priority to U.S. Provisional Patent Application No. 61/429,373 filed 3 Jan. 2011, which is hereby incorporated by reference in its entirety for all purposes as if fully set forth herein.

### BACKGROUND OF THE INVENTION

1. Field of the Invention

Embodiments of the present invention relate, in general, to computer architecture and more particularly to methods and systems involving the wireless transmission and rendering of graphical images.

2. Relevant Background

The widespread use of computers, wireless telephones, personal data assistants and the like has led to a corresponding demand to convey images wirelessly from one device to another. Many techniques have been developed to transmit an image from one device to another efficiently; but in each case a trade off is made between bandwidth, or the ability to carry data from one location to another, and processing power of the device rendering the image.

To conserve or optimize the use of available bandwidth various techniques in the prior art compress data or alter its format so that more data can be transmitted utilizing the same bandwidth. These compression techniques can be very sophisticated and convey large amounts of date using relatively limited bandwidth. The cost of these techniques is processing power. To facilitate the various parameters and compression algorithms needed to convey large amounts of data using a limited transmission bandwidth, both the sending apparatus and receiving apparatus must have sufficient memory and processing power to package and un-package the data. Thus graphical data sent by a computer using a sophisticated compression technique may arrive quickly at its destination only to have its rendering delayed by limiting processing capability of the wireless device. In practical terms this is the reason that one cellular phone or smart phone performs better than another. The compressed data may be arriving at both devices at the same speed but the ability for the device to decompress and process the data varies.

Alternatively, rich graphics can be rendered on mobile devices using relatively unsophisticated processors. However to do so the data which is received by the device must be essentially display ready. One known approach to rendering graphics on a wireless device would be to generate the graphics fully on a host at runtime and to continuously stream complete image frames at the required update rate. This scheme would allow for extremely rich graphics, the richness limited only by the processing power of the host. However, in this model the wireless bandwidth (data rate) requirements are high, especially with a large number of clients. High bandwidth requirements in a wireless system typically result in higher component (e.g. radio) costs and greater power usage, both of which are undesirable for a battery-powered embedded system. However, with high bandwidth, the data can be quickly processed as it arrives and therefore quickly displayed.

Another known approach for controlling and rendering graphics on a client device (or similar devices) is to only use vector graphics (squares, circles, lines, etc.) that can be described in extremely compact mathematical forms. For instance, transmitting the coordinates of a square over a wireless channel requires much less data than transmitting every pixel of the square. In this model, at runtime the host would transmit vector draw commands wirelessly to the client as-needed to update the display. This scheme could potentially keep wireless bandwidth requirements lower than the full-frame streaming approach, however generating rich graphics would require either (1) a high degree of processing on the remote device so as to interpret a wide range of vector shapes (requiring a more expensive, power-hungry processor) or (2) a greater rate of simple vector draw commands (which would increase bandwidth requirements thus defeating the purpose of the approach).

Accordingly there is a constant balance in achieving rich graphics on a client device between increasing bandwidth and processing power to more easily accommodate rich graphics and the desire to conserve batter life by keeping bandwidth and processing requirements low. Thus a challenge remains to present rich graphics on a collection of wireless devices while keeping components costs, power usage, and wireless bandwidth requirements low. These and other deficiencies of the prior art are addressed by one or more embodiments of the present invention.

### SUMMARY OF THE INVENTION

A method for rendering graphics wirelessly on a thin client is hereafter disclosed using a distributed graphic engine. According to one embodiment of the present invention, graphical data and graphical instructions are preloaded on one or more client devices. The rendering of images on a thin client is controlled by a host computer or server which initiates instructions or commands for the client device to access the stored data and/or instructions to efficiently render graphics on the client. The preloaded graphical instructions and preloaded graphical data can be in the form of firmware, or loaded to the clients during manufacture on an as needed basis during the initial phase of a host-based application, during runtime of the application or any combination thereof.

The distributed graphic engine of one or more embodiments of the present invention stores graphical data and instructions on thin client devices using memory that is controlled and managed by host computer using wireless commands. According to another embodiment of the present invention the rendering of graphics on the client can be accomplished by using a combination of preloaded graphical data and graphical instructions combined with streaming graphical data from the host as well as graphical instructions transmitted on-the-fly from the server to the client. Moreover a sequence of commands or a single command which initiates a sequence of actions can also be transmitted from the host to the client.

The features and advantages described in this disclosure and in the following detailed description are not all-inclusive. Many additional features and advantages will be apparent to one of ordinary skill in the relevant art in view of the drawings, specification, and claims hereof. Moreover, it should be noted that the language used in the specification has been principally selected for readability and instructional purposes and may not have been selected to delineate or circumscribe the inventive subject matter; reference to the claims is necessary to determine such inventive subject matter.

### BRIEF DESCRIPTION OF THE DRAWINGS

The aforementioned and other features and objects of the present invention and the manner of attaining them will become more apparent, and the invention itself will be best understood, by reference to the following description of one or more embodiments taken in conjunction with the accompanying drawings, wherein:

FIG. 1 shows a wireless networked computer environment in which the present invention is implemented;

FIG. 2 shows a high level block diagram of a general system architecture for a distributed graphics engine according to one embodiment of the present invention;

FIG. 3 shows a distributed graphics engine communication packet structure according to one embodiment of the present invention;

FIG. 4 shows a distributed graphics engine data packet structure according to one embodiment of the present invention;

FIG. 5 is an example of a command structure issued by a host computer directing a client device to render a graphical image on the client based on preloaded graphical data and preloaded graphical instructions according to one embodiment of the present invention;

FIG. 6 is an example of various communication protocols between a client device and a host computer used to verify the accuracy and integrity of preloaded graphical data and preloaded graphical instructions on the client device;

FIG. 7 shows a flow chart of one method for distributing graphic processing and data according to one embodiment of the present invention; and

FIG. 8 shows a flowchart of one method for updating preloaded graphical data and preloaded graphical instructions and for keeping the image rendered accurately on the client device according to one embodiment of the present invention.

The Figures depict embodiments of the present invention for purposes of illustration only. One skilled in the art will readily recognize from the following discussion that alternative embodiments of the structures and methods illustrated. Other embodiments of the invention described herein may be employed without departing from the principles of the invention described herein.

### DESCRIPTION OF THE INVENTION

The following description with reference to the accompanying drawings is provided to assist in a comprehensive understanding of exemplary embodiments of the present invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces. The terms “comprising,” “having,” and “including” are synonymous, unless the context dictates otherwise. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present). In addition the phrase “A and/or B” means “(A), (B)”, or “(A and B)”. The phrase “at least one of “A, B and C” means “(A), (B), (C); (A and B), (A and C), (B and C) or (A, B and C)”.

“Of,” “the,” “a” or “an” are employed to describe elements and components of the embodiments herein. This is done merely for convenience and to give a general sense of the invention. This description should be read to include one or at least one and the singular also includes the plural unless it is obvious that it is meant otherwise.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Included in the description are flowcharts depicting examples of the methodology which may be used to distribute graphical processing between a server and client device. One of reasonable skill in the relevant art will recognize that the label “server” and “client” are relative and arbitrary. Accordingly in a system of multiple devices anyone device, based on capability and relationship to the other devices can fulfill the role of either client or server. In the following description, it will be understood that each block of the flowchart illustrations, and combinations of blocks in the flowchart illustrations, can be implemented by computer program instructions. These computer program instructions may be loaded onto a computer or other programmable apparatus to produce a machine such that the instructions that execute on the computer or other programmable apparatus create means for implementing the functions specified in the flowchart block or blocks. These computer program instructions may also be stored in a computer-readable memory that can direct a computer or other programmable apparatus to function in a particular manner such that the instructions stored in the computer-readable memory produce an article of manufacture including instruction means that implement the function specified in the flowchart block or blocks. The computer program instructions may also be loaded onto a computer or other programmable apparatus to cause a series of operational steps to be performed in the computer or on the other programmable apparatus to produce a computer implemented process such that the instructions that execute on the computer or other programmable apparatus provide steps for implementing the functions specified in the flowchart block or blocks.

Accordingly, blocks of the flowchart illustrations support combinations of means for performing the specified functions and combinations of steps for performing the specified functions. It will also be understood that each block of the flowchart illustrations, and combinations of blocks in the flowchart illustrations, can be implemented by special purpose hardware-based computer systems that perform the specified functions or steps, or combinations of special purpose hardware and computer instructions.

With respect to most graphical displays, modern-day computer graphics systems contain specialized rasterizing hardware separate from the main computer processor that aid in generating computer graphics. The specialized rasterizing hardware generally includes a dedicated processor that generates images through a combination of pre-loaded textures, vertex (point) arrays and programmable code libraries that are driven by application level code running on the main processor. The application level code resident on the computer communicates with the specialized hardware through a data bus such as Peripheral Component Interconnect (PCI), Accelerated Graphics Port (AGP) or similar, controlling it in in such a way as to render graphics at runtime. Often care is taken in the design of these architectures to reduce the amount of traffic across the bus in order to maximize graphics performance.

A computer interface developed by Sifteo Incorporated comprises a collection of small interactive devices that users physically manipulate by hand. These small interactive and manipulable devices are referred to, as would be known to one of reasonable skill in the art, as a “Sifteo cube”. A collection of Sifteo cubes (also referred to hereafter as a client) can communicate wirelessly with other processors or a computer (referred to hereafter synonymously as a “host” or “server”). Each Sifteo cube has one or more graphical displays that can be controlled by the host at runtime to display dynamic animations and other graphical feedback. The display of dynamic animations on Sifteo cube’ screens requires graphics that can be driven at interactive real-time rates.

A distributed graphic engine suitable for use on small interactive devices that can be physically manipulated by a user is hereafter described by way of example. According to one embodiment of the present invention, a distributed graphic engine (DGE) is comprised of 2 main elements, an embedded graphic engine and a host graphic engine, that communicate with each other wirelessly over a low bandwidth link to produce a rich graphical display on a manipulable (client) device.

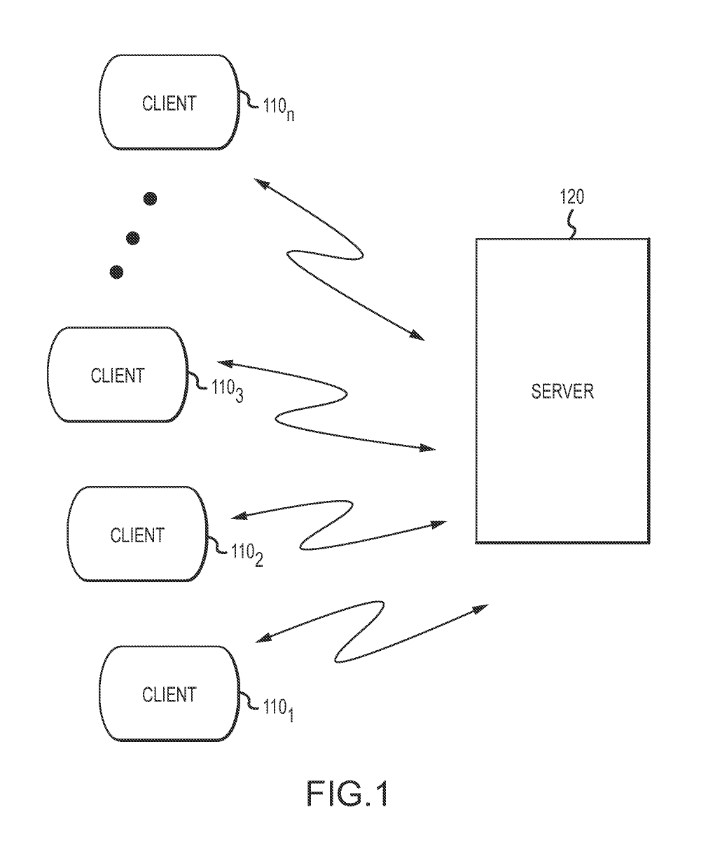

FIG. 1 shows a high level architecture schematic of a distributed graphic engine according to one embodiment of the present invention. As shown, a host 120 or server computer wirelessly communicates with one or more client computers 110ₙ. In a preferred embodiment each of the client computers is a manipulable interactive device known in the art as a Sifteo cube. With respect to the present invention graphical commands are issued by a server computer 120 and directed to one or more client computers 110. By distributing the various components of the graphical rendering process for each client computer or client device the present invention enables the rich conveyance of graphical data and processing using limited bandwidth and processing capabilities.

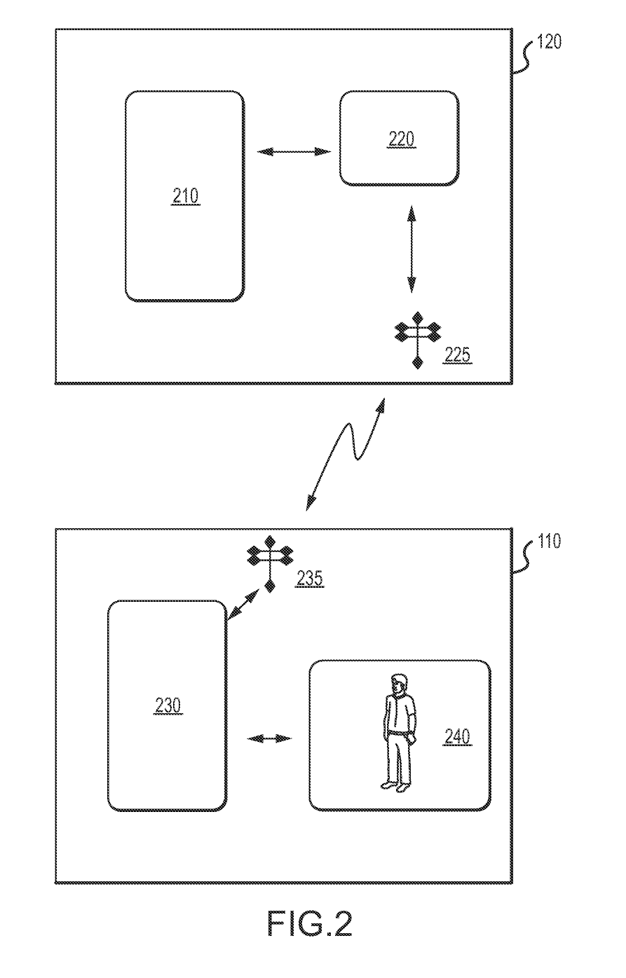

With reference in addition to FIG. 2, a high-level block diagram of an exemplary server computer 120 and one or more client devices 110 can be considered. According to one embodiment of the present invention, a server computer 120 includes, among other things, a storage media 210 and a microprocessor 220. The storage media 210 of the server computer 120 includes one or more libraries comprising graphical data and/or graphical instructions for the controlling of the rendering of the graphical data. The storage media 210, and the inclusive libraries, are communicatively coupled to the processor 220 and to a transmitter 225.

The server computer 120 is further in wireless communication with one or more client devices 110. As will be appreciated by one of the reasonable skill in the relevant art the wireless communication technology between the host (server) and client device can use radio frequency (RF), infrared, or other wireless link technologies. According to one embodiment of the present invention, each client device 110 includes, among other things, a receiver, 235 a storage medium 230, and a display device 240. These components, collectively referred to as the embedded part of the distributed graphic engine, maintain both graphical data and program subroutines that, under control of the server computer 120, can render rich graphical displays on the client device 110 without the use of extensive bandwidth and the need of a high-performance processor.

According to one embodiment of the present invention, graphical data (data of optimally-compressed bitmap or logical images that are decompressed when used including textures and vertex arrays) and program routines are preloaded onto the client device 110 prior to being required for use during runtime by an application running on the server. The stored program routines can operate on the stored graphical data so as to generate rich graphics on the client device without the need to stream graphical data from the server computer.

In another embodiment of the present invention, the preloaded graphical instructions or routines stored on the client device can be part of firmware that is either programmed directly into the client using a protocol such as a joint test action group (JTAG) or a serial wire debug (capital SWD), or can be “boot-loaded” to the client device using a serial port or wireless connection. In the embodiments of the present invention in which the graphical data or graphical instructions are stored in the client device in the form of firmware, the data can be stored in nonvolatile code memory such as the memory in an advanced reduced instruction set computing (RISC) machine (ARM) micro-controller. Commands to alter or delete the graphical data or graphical instructions can be transmitted over the radio and stored in a flash memory module that is separate from the ARM micro-controller. Regardless of how the graphical data is positioned on the client device, all data located on the client device is accessible by the micro-controller.

The graphical data stored on the client device in another version of the present invention can possess unique filenames that each associate with a particular software application. Upon initiation of a particular software application on the host computer, a command is transmitted to the client device which thereafter accesses a unique file stored in memory. The file, which is associated with the application running on the host, identifies stored graphical data and stored graphical instruction sets which accordingly produce graphics on the display of the client device. In another embodiment of the present invention graphical data is stored on the client device without filenames. In this embodiment the data, which is associated with a single application, is accessed by raw addresses issued by the stored graphical instructions or by instructions streamed from the host.

The present invention is compatible with and contemplates numerous means by which to manage the storage and use of graphical data and instruction sets on a client device. Furthermore, the present invention contemplates that the graphical data and program routines preloaded onto the client device, which access and utilize the software program on the host, are updated by the host, in some embodiments during runtime of a particular application. Accordingly, the architecture of the present invention can update the data and routines stored on the client device over a wireless link even as a host continues to run a specific program. For instance, the host can load a new batch of data and routines for a subsequent level of a game presented on the client device during runtime as the current level is played. While the client device renders graphics based on the preloaded graphical data and preloaded graphical instructions, updated data and instructions are downloaded and later utilized by the client device to provide even richer graphics without the cost of excessive bandwidth or processing power on the client device.

For example, imagine a game running on the client which possesses several different levels. Each level includes a basic background but in additional require additional custom features unique to that level. Data and instructions resident on the client device quickly present graphics associated with level one upon instantiation of the game. While the user is one level one, data with respect to level two, not currently resident on the client, streams from the host and is stored on the client. Upon the user reaching level two the data for the graphics associated with level two is present on the client. Once the user is engaged in the second level and level two data is being accessed, level one data is no longer needed. At that time data for the next level or the level in the immediate future, level three in this instance, is streamed from the host replacing level one data or data that is no longer required or anticipated to no longer be required. In such a manner the next likely data requirement is propositioned on the client for immediate access.

As previously described, a graphical image can be rendered on the client device using preloaded graphical instructions in combination with preloaded graphical data while in other embodiments of the present invention a graphical image can be rendered on the client device using graphical data preloaded or stored on the client device in combination with instructions and data wirelessly transmitted to the client device from the host. Alternatively, a graphical image can be rendered on a client device using preloaded graphical instructions or subroutines and graphical data streamed to the client device from the host. The various embodiments of the present invention can optimize the use of the data and instructions present on the client device based on the available bandwidth, capability of the client device and user interaction.

As one of reasonable skill in the relevant art will appreciate and the present invention contemplates, instructions and graphical data preloaded and stored on the client device can be combined with additional graphic data and instructions transmitted from the host at any point during the graphical rendering. The server or host computer includes one or more code libraries and a corresponding application program interface (API) that enables the software program or set of instructions, written by one or more developers and running on the host computer, to control and/or manage the embedded portion of the distributed graphic engine. By accessing one or more of the code libraries and instruction sets stored therein, the host can utilize the available bandwidth to transmit commands to the client device rather than a stream of graphical data that is directly rendered on the client device display. In such a manner the client device can present rich graphical images and animations using data and instructions that are stored on the device while additional data and instructions are delivered to the client device as necessary.

To better understand the various aspects of the present invention, consider the following example. Assume the system exists in which a host computer interacts with the plurality of thin-client devices. Each of these client devices includes, among other things, a storage media, a processor and a display. Each client device is communicatively coupled, wirelessly, to a host. A user interacting with the host device and wishing to use one or more of a plurality of client devices initiates an application. The application which is running on the host device and interacting with each of the plurality of client devices transmits a variety of commands and data packets to one or more of the client devices. Thereafter each of the client devices renders an image on its graphical display based on the instructions and data streamed from the host. In order to minimize the bandwidth required to transmit the data and associated instructions and to present graphical images on each of the client devices in a low-latency manner, one or more portions of graphical data in graphical instructions can be preloaded onto the client devices. One of reasonable skill in the relevant art will recognize that an application has referred to the present invention is comprised of a set of instructions that can be executed by a machine such as a processor. For the purpose of the present invention an application, software, and a set of instructions are synonymous.

Assume for this example that a user desires to play a game utilizing three client devices. While the rendering on the display of each client device is related, the instructions relating to the actual rendering are individually unique. To provide the user with rich graphical imagery to drive the game, the displays on each of the client devices can immediately display one or more graphics using internally stored instructions and data. Upon the user selecting a particular game the host computer communicates with each client device which of a plurality of applications is being initiated. This communication alerts each client device as to what set of instructions and graphical data preloaded onto the client device will be accessed. In another embodiment of the present invention, the host, upon a user initiating a particular game, transmits graphical data and/or commands to each client device. As a host device loads the application software commands as well as (in some instances) additional data and instructions are transmitted to each client device. With each client device possessing preloaded and data preloaded instructions, and with the host application initiated, the user can begin interacting with the client device(s) and or host immediately. As the user interacts with, for example, the client device the interaction is relayed back to the host. The host application software determines what images or animations should be displayed on that particular client device as well as the other associated client devices used in this particular application.

Rather than streaming new graphical data to the client device which would then be displayed on the client device, the host computer determines which instructions or commands are to be sent to the client device. This will then trigger a subsequent rendering on the client device display. Similarly the host computer can transmit commands to the other client devices to access preloaded data and/or instructions to modify the images on their respective displays. Depending on bandwidth availability and the need to transmit additional data and instructions to the one or more client devices involved in the game, the host computer can thereafter send supplemental data and/or instructions to the client device. This supplemental data and instructions can be used in conjunction with or in substitution of the preloaded data and instructions. Furthermore, the other client devices that are not actively being manipulated or utilized by the user can continue to communicate with the host and load and store additional graphical data and instructions.

As the application running on the host computer proceeds, a command can also be sent to the one or more client devices triggering a series of instructions. As with all instructions and graphical data, this series of instructions may be preloaded before, at, or during the runtime of the application. Therefore with a single command transmitted from the host to the client device a wide variety of pre-sequenced, preloaded graphical renderings can be displayed on the client device. Accordingly the game, or the application initiated by the host, can begin before all the graphical data and information has been transmitted to the client device.

The host, in one embodiment of the present invention, can send graphical data needed to begin the game during, for example, the loading phase so that the game can start and then supplement the data to that and other devices as a game is being played. In another embodiment of the present invention fragments of code can be transmitted to the client device as a particular game or application is being run. In such an embodiment, if a particular application requires more graphical data than can be stored at a client device, the host can transmit the appropriate fragments as the game proceeds. For instance each particular level of the game or application can be transmitted on an as needed basis so that at any given moment the client device is only storing data specific to a local portion of the application as well as data that is common across all particular levels (title, screen controls, user interface controls, etc.). For example, in a game in which there are multiple levels there may be a portion of the graphical background which is common throughout the game and throughout each level. This common graphical data and instructions to render this data can be preloaded on each of the client devices while the particular data and instructions for each level can be transmitted from the host on an as-needed basis and combined at the client at the time of rendering. The transmission of the data and instructions from the host to the client is conveyed using a packet structure unique to various embodiments of the present invention.

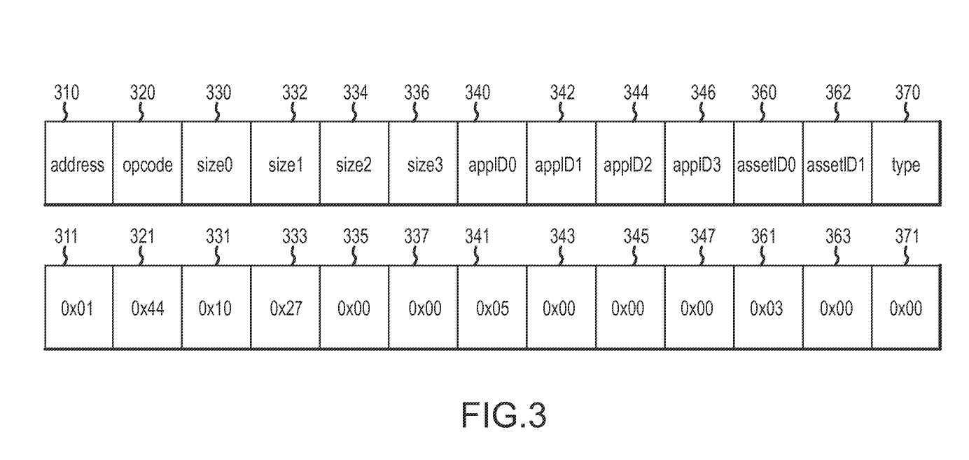

FIG. 3 illustrates an example of a packet structure used to convey graphical data from a host computer to a client device according to one embodiment of the present invention. As previously described, in one embodiment of the present invention, graphical data is transmitted over a wireless link from the host to a client device upon initiation of a particular application. In other embodiments the graphical data and associated instructions can be preloaded onto the client device or stored in firmware of the client device. In versions of the present invention in which data is loaded to the client device upon the initiation of the application on the host, the packet structure of FIG. 3 illustrates how that transference of data might occur.

Upon reaching the decision to convey data to the client device the host identifies the data with a specific label, for instance “my image”. Thereafter the host initiates a software package transfer to a specific client device using a structure as, for example, shown in FIG. 3. In the first block of the packet shown in FIG. 3 the host computer identifies in which client device the data is to be stored. Should the data be stored in multiple client devices, similar packets of data with different addresses must be transmitted to each client device. The address 310 indicates, in this example, the client device 01 311 is about to receive graphical data. The Opcode 44 320, 321 indicates that this packet identifies an initial installation command. The subsequent 4 size bytes 330, 332, 334, 336 provide the client device with information about the size (in bytes) of graphical data that is about to arrive. In this case size field numbers 330, 332, 334, 336 identifies that the graphical data will contain hexadecimal 2710, or 10,000 bytes. Immediately following the size fields 330-337 are 4 bytes 340, 342, 344, 346 for storing an application identification number. In this case the application ID field, appIDO 340 identifies application 05 341 while the other values are empty. The next two bytes in the packet structure identify numerical identifiers for this particular piece of graphical data. Here the asset ID 360, 362 is the number 3 361. Lastly the type field which is the last field in the packet structure 370 identifies the type of data that is to be installed on the client device. For example the data may be bitmapped data encoded data or other data formats as would be known to one of reasonable skill in the relevant art.

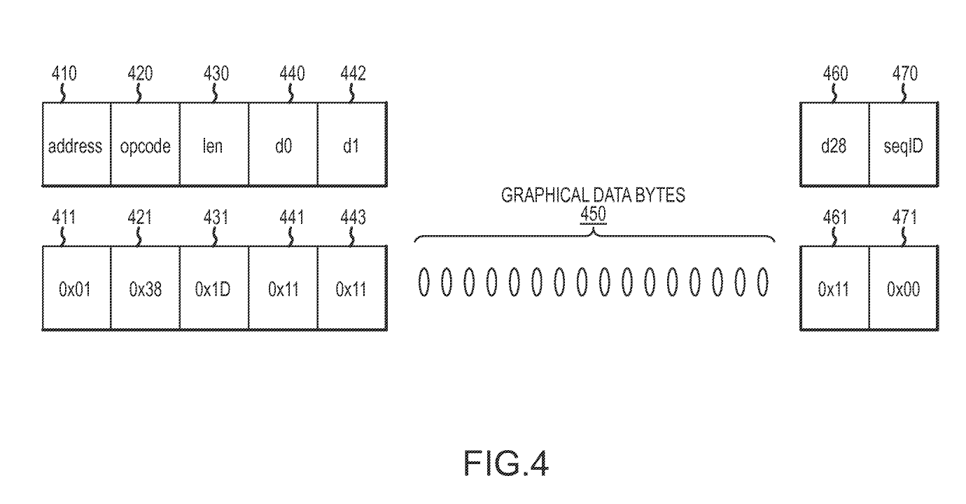

Once the client device has received a packet of this type, the device is aware that it will soon be receiving graphical data and/or instructions that are to be stored for later use. FIG. 4 shows an example of a packet structure used to transmit graphical data. In this example the first two fields, the address 410 and Opcode 420 are the same as shown in FIG. 3. The next field 430 encodes the number of remaining bytes in each packet. The sequence ID field 440, 442 increments by one for each packet. This field insures that the client device can detect if a packet arrives out of order and thus cancel installation. Thereafter, the graphical data bytes 450 are transmitted from the host to the client device. After the last byte of graphical data is received its integrity is verified using a checksum located at the end of the data 460. If the downloaded graphical data passes the checksum verification it becomes available as part of the distributed graphic engine located on the client device. Lastly the packet terminates with the sequence ID number 470 indicating the end of the packet.

Once the graphical data is installed on the client device it remains dormant until triggered by a command initiated by the host. To render the graphical data on the client device, an application program running on the host calls a function from its libraries and, using an application programming interface, passes required parameters from the host to the client device. For example the command may resemble:

sift.image
(<name>,<screenX>,<screenY>,<sourceX>,<sourceY>,<chunkW>,<chunkH>)
sift.image(“myimage”,20,20,10,10,24,24)
where “sift” is the name of the client device that has been initialized by the host. Likewise, “image” is the function that is used to display a portion of an image from stored graphical data and “name” is the symbol used to uniquely reference the given graphical data (in this example, application ID has been configured in a previous command, and the translation from the “name” symbol to the numerical ID of the graphical data is done by the Host API). The terms “screenX” and “screenY” specify the on-screen coordinates where the graphical data will be drawn. Terms “sourceX”, “sourceY”, “chunkW” and “chunkH” specify the coordinates within the graphical data from which to begin reading, and the size of the data chunk to draw.

In other versions of the present invention the terms such as “screen X” and “screen Y” can be resident undistorted instructions on the client device. The command initiated by and sent from the host computer can merely identify an instruction on the client device which in turn can generate specific instructions to render the graphical data on the display device at the client site.

In another embodiment of the present invention the command transmitted by the host or server to the client device can identify a plurality of previously stored instructions on the client device. By issuing such a command a series of actions on the client device can take place. Alternatively the command initiated by the host can identify a particular instruction or set of instructions located on the client device and join those instructions with streaming data provided by the host. Similarly the command that is initiated by the host can provide instructions to the client device to utilize graphical data resident on the client combined with streaming data to generate the images on the display. One of reasonable skill in the relevant art will recognize the various combinations of preloaded graphical data and graphical instructions can be combined with streaming data and streaming instructions from the host to result in a graphically rich display of images on a client device.

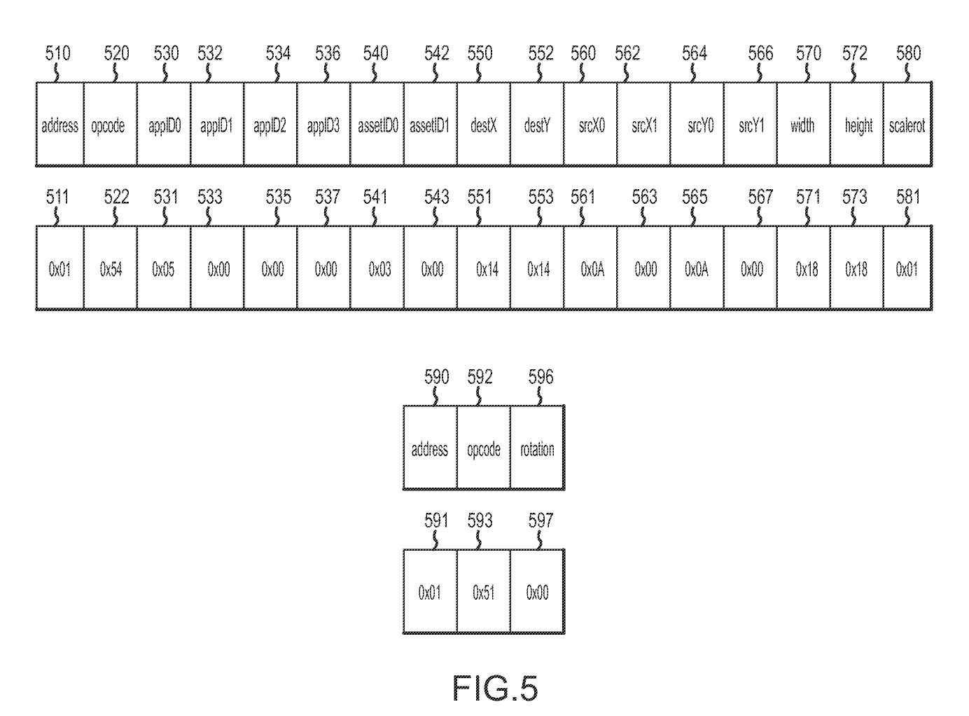

Returning to the previous example, the host or server computer generates a message that is transmitted over a wireless link to the client device. The message includes, among other things, the client device address, the file to use, the location and size of the portion of the file to use, and the on-screen position on which to draw the pixels. FIG. 5 presents an example of a command issued by a host computer to a client device to render a graphical image on the client display using preloaded graphical data and/or preloaded graphical instructions. As can be seen in FIG. 5, and referring back to prior examples shown in FIG. 3 and FIG. 4, the commands “address”, “application ID 0”, “application ID 1”, “application ID 2”, “application ID 3”, “asset ID 0”, and “asset ID 1” are the same as above. The terms “destination X” and “destination Y” specify the on-screen quarters where the graphical data will placed. The remaining terms such as “SRC X0”, “SRC X1”, “SRC Y0”, “SRC Y1”, “Width”, and “Height” specify the coordinates within the graphical data from which to begin accessing pixels and the size of the drawing area.

To initiate the command to draw the image on the client device the host or server triggers the instructions on the client device to initiate the rendering. For example, the host sends a command “device.repaint”. Such a command issued by the host is also shown in FIG. 5 in which the command 0X51 593 is the “repaint” code and the 0X00 597 associated with rotation field refreshes the screen without any rotation of the frame buffer.

The client device, upon receiving the command from the host, fetches the appropriate portion of stored graphical data from the onboard flash memory or other memory media located on the client device and copies it, in one embodiment, to the frame buffer at a specified location. Thereafter the graphical display is updated with the contents found in the frame buffer. In another embodiment of the present invention the use of the frame buffer is bypassed by writing directly to the display. In such an embodiment a rendering instruction buffer can be interpreted in a mode dependent manner.

Error correction algorithms, as would be known to one of reasonable skill in the art, ensure that the message conveyed over the wireless link from the host to the client device is accurate. Moreover multiple commands can be conveyed to the host in a single radio packet.

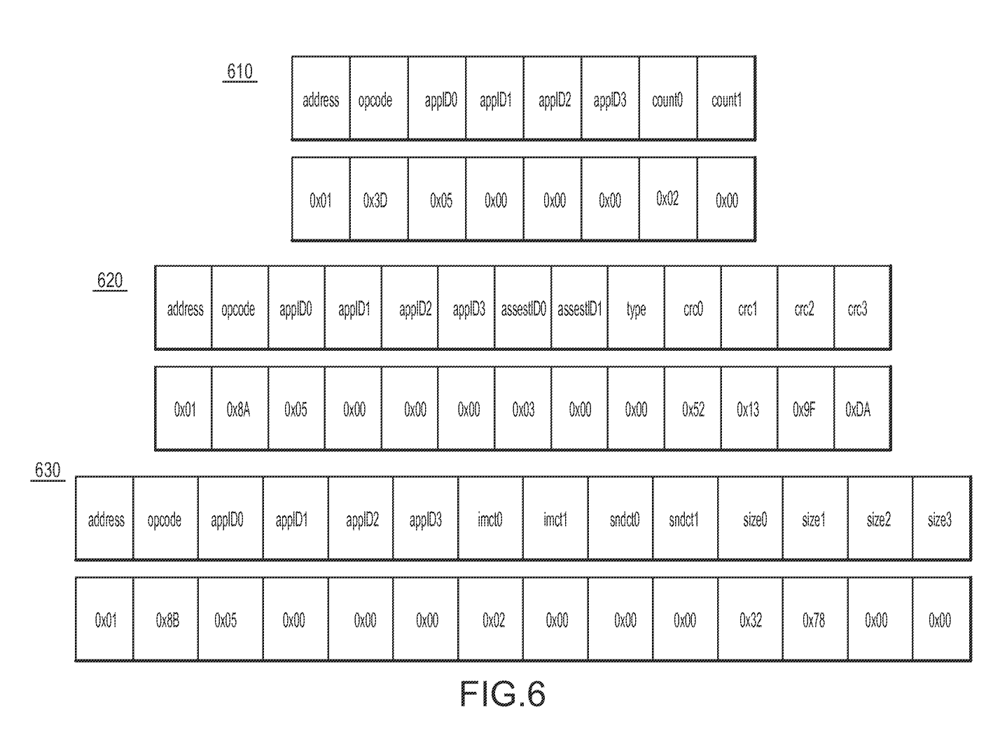

Another feature of the present invention is the ability of the host or server computer to verify that a particular client device possesses the necessary preloaded graphical data and/or preloaded graphical instruction to support a particular application or segment thereof. By using a particular command structure packet the server can verify the existence of the required code or graphical data. FIG. 6 presents a series of commands shown in the packet structure issued by a host computer to verify the existence of preloaded graphical data and/or preloaded graphical instructions on a client device prior to the initiation of a particular application. Note that in an instance in which the host loads data and instructions at runtime, as described in another embodiment, the host only needs to know that the data and/or instructions have been received successfully by the client. A query, in this type of interaction, is not necessary.

Returning the previous example and according one embodiment of the present invention, the server or host maintains a required listing of graphical data for a particular application. Any time the host can request the client device to report a summary of its installed graphical data and/or graphical instructions for any particular application. Such a request 610 presents to the client device which portions of code the host wishes to verify. Upon receipt of such a command the client device examines its preloaded graphical data and/or instructions for a particular application and transmits a response packet 620 back to the host. Lastly the client device, upon reporting all relevant graphical information, transmits to the host a message 630 that it has completed its search and reported all requested information to the host. The host, having received a message from the client device, verifies each asset stored on the client device matches the stored checksum for that given asset. The host also verifies that the client device possesses the correct number of assets for the requested application. If the client device has an incorrect number of assets or one or more of the assets fails to pass verification checksum, the host can reinstall the deficient asset.

According to another embodiment of the present invention the host computer or server maintains change bitmaps (logic maps) to keep an accurate model of what is shown on the displays of each client device. By maintaining these representations of the client displays the host device can determine if an on screen region requires updating based on recent API calls from the running application. In such a manner the host maintains a verifiable and accurate representation of what is being displayed on the client device. By queueing or otherwise collecting a representation of one or more of the intended recent graphical updates to the client display indicated by instructions executed by the running application, periodically comparing the collection of recent updates and the logical model and executing the appropriate instructions stored in library(ies), the server can harmonize the image rendered on the client device with the recent updates by the running application. Further, the server can implement efficiencies such as graphical coalescing or smart instruction culling in order to minimize the amount of communication to the client required.

According to another embodiment of the present invention the host can alert the client device to store particular sequences of draw commands (either at or before runtime) in such a way that these sequences may be invoked subsequently with minimal communication required over the wireless link. For instance, the drawing of a particular pose (e.g. “CROUCH”) of an on-screen character can require accessing several assets and coordinating their presentation on the display. The instruction(s) to carry out a particular sequence can be transmitted to and stored on the device.

Once stored, the host can trigger the drawing of the character in the “CROUCH” pose by invoking the stored sequence of commands as a single command, for example by passing the string “CROUCH” or some assigned Opcode as an identifier. Such a system can allow the host application to modify the stored sequence, for instance by passing values for variables that are used in the sequence. For instance, the on-screen coordinates of the “CROUCH” call thus can be passed. Such sequences of commands can also, according to another embodiment, have a temporal aspect. For instance they can implement an animation that takes place over time. In this case, higher-level control of such sequences of commands may be part of the API, for instance to allow actions such as setting the speed or duration, cancel, pause, reverse, loop, speed up/down, etc. This variation saves on communication bandwidth for compound/complex draw sequences while utilizing the existing functionality of the graphics engine.

An application running on the host can also, in another embodiment, transmit fragments of code to the client device graphics engine (either=before, at, or during runtime) in a manner similar to the upload of graphical data. These code fragments could be full libraries or small individual program routines in a form executable by the client. Their purpose, among other things, can be to add specific functionality to the embedded part of the graphics engine and to achieve one or more of: (a) further reduce the required amount of radio traffic when rendering rich graphics by pushing more functionality to the client, (b) install application-specific functionality that is not part of the default instantiation of the client embedded portion, and/or (c) install graphics functionality that must be resident on the embedded part due to performance reasons (i.e. routines that can only execute quickly enough when installed directly on the client). Once installed, the code fragments can then be invoked by the host. For example, a function called “boom” for animating explosions may be installed to the client. Once installed and verified, the program code on the host may call the installed function as follows:

sift.boom(<explosiontype>,<screenX>,<screenY>,<radius>,<duration>) siftable.image(“atomb”,64,64,25,2)

This call would generate an explosion animation of type “atomb” at location (64,64) on the client's display with, for example, a radius of 25 pixels that animates over a period of 2 seconds.

The code fragments can, in one embodiment of the present invention, be in the form of byte-code that is executed by an interpreter on the client's CPU, or they can be in the form of native code that runs directly on the CPU. The code can be constrained to only access graphics functions on the client device, or it can be able to access other functions of the embedded system. Another example is a code fragment that implements anti-aliasing. This program routine can replace the “sift.image” function described above, allowing the host to instead call “sift.antialiasedimage” to present the specified image fragment in a way that is antialiased against the background graphics already being shown on the display.

According to another aspect of the present invention the amount graphical data that must be transmitted to the client device in order to render an image can be reduced. It will be appreciated by one skilled in the relevant art that computation overhead is incurred when decompressing spatially-compressed or color-space compressed graphical data, for instance a JPEG-compressed image. In one embodiment of the present invention some of the graphical data is encoded as rectangular tiles, and these tiles are stored on the client in uncompressed form in order to make rapid access possible with minimal computational overhead. The amount of data transmitted to the client device can be minimized by reducing the number of distinct tiles. According to one embodiment of the present invention a compression tool can optimize the total set of tiles transmitted to a client device using a graphical display by particular application so as to identify and “merge” perceptually similar tiles for transmission to the client.

To identify perceptually similar tiles, according to one embodiment of the present invention, an error metric combining multi-scale error (MSE) techniques and a comparison of the Sobel gradient approximation is used. This metric can be weighted toward the preservation of low-frequency color information and high-frequency contrast information to produce rich graphics at minimal cost and minimal memory requirements. By gathering similar tiles into stacks they can be represented at any given time by a pixel-by-pixel median of all the tiles in a particular stack. Thereafter, depending on how many colors a particular tile possesses, each tile can be compressed and represented using a narrow color lookup table. For example tiles can be represented with 1, 2, 4, 6 or a non-limited number of colors bits. Each of these color depths can possess a different custom-tailored RLE compression scheme. The palettes are compressed by reordering the tiles so as to minimize the number of color LUT entry replacements.

Depending on the desired level of graphical data-compression “aggressiveness”, groups of perceptually similar tiles transmitted to the client as a single tile that is perceptually characteristic of the range found in a particular group. Then when a graphic is rendered, any of the tiles from a given group will be represented by a single “common” tile that perceptually best represents the whole range.

By reusing “perceptually similar” tiles the amount of memory space required for the storage of graphical data on the host and for transmission to each client device is greatly reduced without a corresponding loss of graphical distinctiveness in the corresponding renderings.

According to one embodiment of the present invention a graphical display on a client device is driven by the device as two layers of square multi-pixel tiles arranged in distinct grids that can be moved in single-pixel increments with respect to the graphical frame, and single a layer that can present graphical sprites at any location in-between the tile layers, all graphics in full color with support for chroma-key transparency.

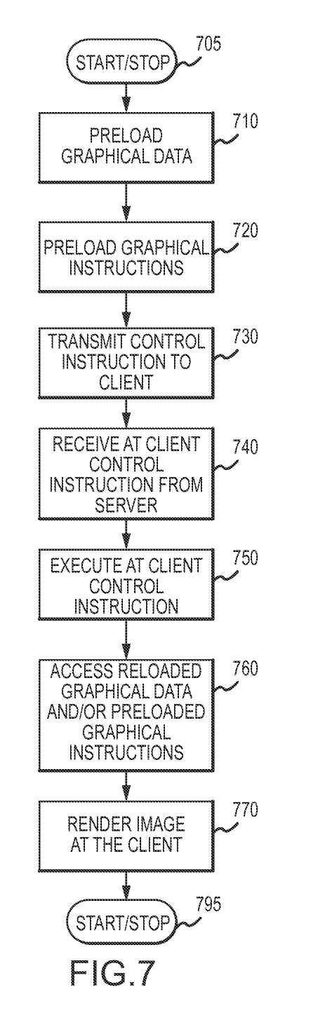

FIG. 7 depicts a flowchart of one method embodiment for distributing graphic functionality between a server and a client device according to the present invention. As previously described the distributed graphic engine of the present invention begins 705 with the preloading of graphical data 710 and preloading of graphical instructions 720 on the client device. In one version of the present invention the graphical data and graphical instructions are transmitted 730 from the host or server computer to the client device. In other versions of the present invention the preloaded graphical data and/or preloaded graphical instructions are programmed into the client device as firmware or are loaded during the boot sequence of the particular application.

Once the preloaded graphical instructions and preloading graphical data are resident on the client device they are accessible by the host by one or more commands. The host device in response to an application (a game for instance) identifying the need to render a particular graphic on the client device identifies that the graphical data and/or specific graphical instructions have been preloaded to one or more client devices. Thereafter the host can initiate a transmission to control and/or trigger the rendering of graphical data on the client device. In another embodiment of the present invention the host can supplement graphical data or the graphical instructions preloaded on the client device to render the appropriate image. In such a manner one or more portions of the graphical data or graphical instructions can be preloaded on the client device using available bandwidth during noncritical intervals. Upon instantiation of an application or part of an application in which key or critical components of the image that is to be rendered on the client are not yet preloaded, the critical items can be quickly transmitted to the client device so as to allow the application or part of the application to quickly begin.

Upon receiving an instruction from the host 740, the client executes the control instruction 750 and accesses 760 the preloaded graphical data and/or preloaded graphical instructions. Once the graphical instructions and/or graphical data are accessed by the client device the client device uses that information to render 770 the graphic on its display ending the process 795.

As previously described the rendering of the graphic on the client device is not limited to preloaded graphical data and/or preloaded graphical instructions. While the client device can use the preloaded graphical data and preloaded graphical instructions to render a graphic on its display as directed by the host, the client device can also render graphics using a combination of the preloaded data and/or instructions with instructions and data streamed from the host.

Moreover, in other embodiments of the present invention the preloaded instructions stored on the client device can initiate a sequence of events accessing various assets of stored graphical data to result in animation or a sequential rendering of static images. The sequential rendering of a graphic on the client device can be triggered by one or more commands issued in a single packet or multiple packets from the host. Furthermore the host can transmit code fragments which can be used to supplement the already established preloaded instructions.

Subsequent to the loading of the preloaded graphical data and preloaded graphical instructions on the client device, the host can initiate verification and accuracy of the stored data. By initiating a series of commands the host can direct the clients to examine preloaded graphical data and preloaded instructions and convey to the host an inventory or verification code or checksum of what is stored on the client device. The host can confirm the validity and accuracy of the data stored on the client and determine if any particular fragments of code or graphical data are absent. Should the host determine that the data or code is inaccurate or absent the host can initiate a reloading of the missing information.

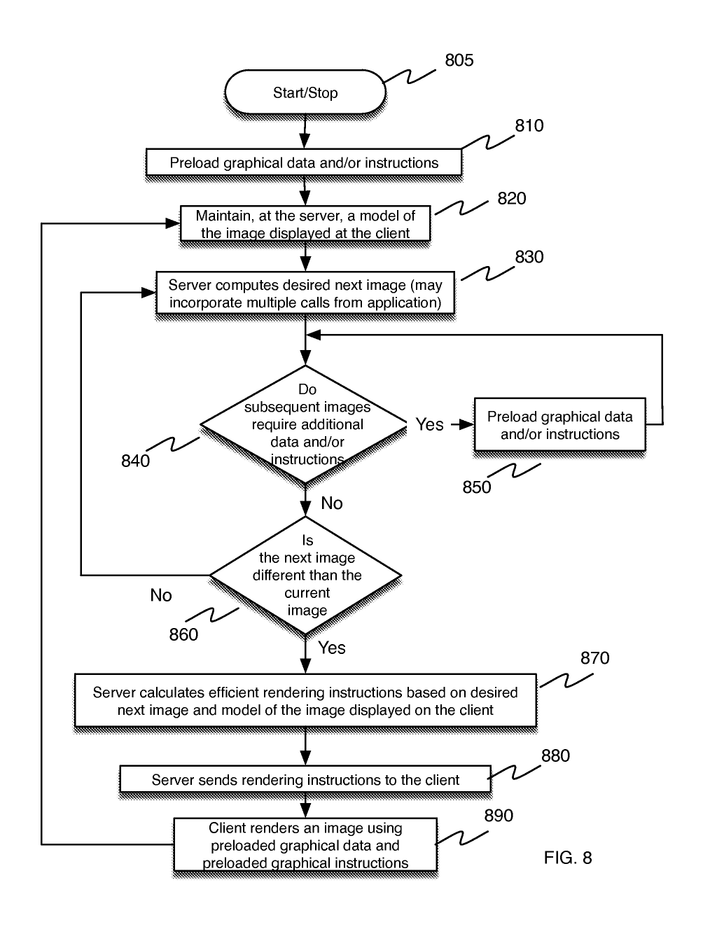

According to another embodiment of the present invention, and as shown in FIG. 8, the data and instructions stored on the client device that are used to render an image on the client can be verified and if necessary supplemented by the server. Such a process begins 805 with the preloading 810 of graphical data and graphical instructions on the client device. Once the graphical data and graphical instructions have been preloaded on the client, the server, upon instantiation of an application, maintains 820 a model of the image displayed at the client. Thereafter, the server computes 830 the next desired image on the client based on the current running application. To do so the server may incorporate multiple calls from the application to determine what will be the next image.

With the subsequent image computed, the server determines 840 whether the client requires additional data or instructions. One of reasonable skill in the relevant art will recognize that the placement of this inquiry is arbitrary. In other embodiments the application running on the server to test whether subsequent images to be rendered on the client would require additional data at any point of the process and there after trigger the download of the data. Returning to FIG. 8, when the server determines that the client requires additional graphical data or instructions, such data and/or instructions are preloaded 850 to the client prior to being accessed for rendering. If the server determines that the subsequent images do not require any additional data and/or instructions 840, and inquiry is made whether the next image is different than the current image being displayed at the client 860. When the next image is determined to be identical to the present image displayed at the client, the server iterates this process to again determine what the next image will be based on the current running application.

When server determines that the next image is different than the current image displayed by the client, and having already determined that the client possesses the required data and instructions, the server calculates 870 efficient rendering instructions (commands) based on the desired next image and model of the image displayed on the client. The server then sends 880 these rendering instructions to the client. And, upon receipt of the instructions, the client renders 890 an image using the preloaded graphical data and preloaded graphical instructions.

The various embodiments of the present invention describe a distributed graphics engine that includes graphical data and graphical instructions preloaded on the thin client device, which is in wireless communication with a host device. In one embodiment the client device comprises a set of compact manipulable blocks or devices, Each block includes, among other things, a micro-controller, battery, a feedback mechanism (such as a display or auditory generator) accelerometer sensor, onboard memory, button/click sensor, and sensors for detecting nearby blocks (such as radio, sonic, ultrasonic, visible light, infrared, image-based (camera) capacitive, magnetic, inductive or electromechanical contact sensors). One or more blocks can process some of the sensor input events into higher-order formulations, either to trigger immediate feedback on the blocks using preloaded data and/or instructions or for transmission to the software architecture on the host (server). This architecture allows actions performed by a user on a client to trigger state or behavior changes on the blocks and on the host, including but not limited to executing subroutines or modifying locally or remotely stored variables or data.

Upon initiation of the particular application on the host, the host device or server can transmit one or more commands to the client device (blocks) to render a particular graphic locally. Rather than streaming graphical data to the client device which is then rendered on display, the host can transmit one or more commands which initiate or trigger a series of instructions utilizing graphical data preloaded on the client device to render a particular graphic or animation. While that graphic is rendered the host can supplement its graphical data or use the preloaded graphic data in combination with streaming data to render a rich display. Using the techniques and concepts described in the present invention, the necessary bandwidth requirements for rendering a rich graphical display between a host and client can be significantly reduced while at the same time minimizing client processor power and cost.

One or more portions of the present invention may be implemented on a conventional or general-purpose computer system, a laptop computer, a notebook computer, a handheld or pocket computer, and/or a server computer. Such a system generally comprises a central processing unit(s) (CPU) or processor(s) coupled to a random-access memory (RAM), a read-only memory (ROM), a keyboard, a display or video adapter connected to a display device, a removable (mass) storage device (e.g., floppy disk, CD-ROM, CD-R, CD-RW, DVD, or the like), a fixed (mass) storage device (e.g., hard disk), a communication (COMM) port(s) or interface(s), and a network interface card (NIC) or controller (e.g., Ethernet). In other embodiments of the present invention a more specialized general-purpose computer can be utilized comprising a processing capability and a limited user interface yet maintain the ability to independently run and process software applications.

Generally a CPU (which may be resident on the client, server or both) comprises a suitable processor for implementing the present invention and communicates with other components of the system via a bi-directional system bus (including any necessary input/output (I/O) controller circuitry and other “glue” logic). The bus, which includes address lines for addressing system memory, provides data transfer between and among the various components. Random-access memory serves as the working memory for the CPU. The read-only memory (ROM) contains the basic input/output system code (BIOS)—a set of low-level routines in the ROM that application programs and the operating systems can use to interact with the hardware, including reading characters from the keyboard, outputting characters to printers, and so forth.

Mass storage devices provide persistent storage on fixed and removable media, such as magnetic, optical, or magnetic-optical storage systems, flash memory, or any other available mass storage technology. The mass storage may be shared on a network, or it may be a dedicated mass storage. The fixed storage stores a body of program and data for directing operation of the computer system, including an operating system, user application programs, driver and other support files, as well as other data files of all sorts. Typically, the fixed storage serves as the main hard disk or storage media for a system, including in this case, the server and the client(s).

In basic operation, program logic (including that which implements methodology of the present invention) is loaded wirelessly, from the removable storage, or fixed storage into the main (RAM) memory, for execution by the CPU. During operation of the program logic, the system accepts user input from various interfaces.

The computer system, be it the client and/or host, displays text and/or graphic images and other data on the respective display device. A video adapter, which is typically interposed between the display and the system's bus, drives the display device. The video adapter, which includes video memory accessible to the CPU, provides circuitry that converts pixel data stored in the video memory to a raster signal suitable for use by a cathode ray tube (CRT) raster or liquid crystal display (LCD) monitor.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve the manipulation of information elements. Typically, but not necessarily, such elements may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” “words”, or the like. These specific words, however, are merely convenient labels and are to be associated with appropriate information elements.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Aspects of the systems and methods described herein may be implemented as functionality programmed into any of a variety of circuitry, including programmable logic devices (PLDs), such as field programmable gate arrays (FPGAs), programmable array logic (PAL) devices, electrically programmable logic and memory devices and standard cell-based devices, as well as application specific integrated circuits (ASICs). Some other possibilities for implementing aspects of the systems and methods include micro-controllers with memory (such as electronically erasable programmable read-only memory (EEPROM)), embedded microprocessors, firmware, software, etc.

One or more portions of the implementation of the present invention may be executed in a Web environment, where software installation packages are downloaded or accessed using a protocol such as the HyperText Transfer Protocol (HTTP) from a Web server to one or more target computers which are connected through the Internet. Alternatively, an implementation of the present invention may be executing in other non-Web networking environments (using the Internet, a corporate intranet or extranet, or any other network) where software packages are distributed for installation using techniques such as Remote Method Invocation (“RMI”) or Common Object Request Broker Architecture (“CORBA”) or the like. Configurations for the environment include a client/server network, as well as a multi-tier environment. Indeed the systems and method described herein contemplate that the a plurality of servers can be linked by one or more networks to provide a rich client based user experience.

It should be noted that components of the various systems and methods disclosed herein may be expressed (or represented) as data and/or instructions embodied in various computer-readable media, in terms of their behavioral, register transfer, logic component, transistor, layout geometries, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof.

Examples of transfers of such formatted data and/or instructions by carrier waves include, but are not limited to, transfers (uploads, downloads, e-mail, etc.) over couplings or connections via one or more data transfer protocols (e.g., HTTP, FTP, SMTP, etc.). The couplings or connections supporting the transfers described above include wired couplings, wireless couplings, and hybrid wired/wireless couplings, but are not so limited.

As will be understood by those familiar with the art, the invention may be embodied in other specific forms without departing from the spirit or essential characteristics thereof. Likewise, the particular naming and division of the modules, managers, functions, systems, engines, layers, features, attributes, methodologies, and other aspects are not mandatory or significant, and the mechanisms that implement the invention or its features may have different names, divisions, and/or formats. Furthermore, as will be apparent to one of ordinary skill in the relevant art, the modules, managers, functions, systems, engines, layers, features, attributes, methodologies, and other aspects of the invention can be implemented as software, hardware, firmware, or any combination of the three. Of course, wherever a component of the present invention is implemented as software, the component can be implemented as a script, as a standalone program, as part of a larger program, as a plurality of separate scripts and/or programs, as a statically or dynamically linked library, as a kernel loadable module, as a device driver, and/or in every and any other way known now or in the future to those of skill in the art of computer programming. Additionally, the present invention is in no way limited to implementation in any specific programming language, or for any specific operating system or environment. Accordingly, the disclosure of the present invention is intended to be illustrative, but not limiting, of the scope of the inventions.

While there have been described above the principles of the present invention in conjunction with a distributed graphics engine, it is to be clearly understood that the foregoing description is made only by way of example and not as a limitation to the scope of the invention. Particularly, it is recognized that the teachings of the foregoing disclosure will suggest other modifications to those persons skilled in the relevant art. Such modifications may involve other features that are already known per se and which may be used instead of or in addition to features already described herein. Although claims have been formulated in this application to particular combinations of features, it should be understood that the scope of the disclosure herein also includes any novel feature or any novel combination of features disclosed either explicitly or implicitly or any generalization or modification thereof which would be apparent to persons skilled in the relevant art, whether or not such relates to the same invention as presently claimed in any claim and whether or not it mitigates any or all of the same technical problems as confronted by the present invention. The Applicant hereby reserves the right to formulate new claims to such features and/or combinations of such features during the prosecution of the present application or of any further application derived therefrom.

We claim:

1. A method for wireless graphic rendition on a thin-client, comprising:
preloading on a client device preloaded graphical data and one or more preloaded graphical instructions; and
controlling rendering of an image on the client device based on an instruction stored in a library on a server executable by the server, wherein the instruction directs, by the client device, use of the preloaded graphical data and/or the one or more preloaded graphical instructions on the client device.

2. The method according to claim 1, further comprising generating the image on the client using the one or more preloaded graphical instructions and/or the preloaded graphical data.

3. The method according to claim 1, further comprising generating the image on the client using the preloaded graphical instructions and graphical data streamed from the server.

4. The method according to claim 1, further comprising generating a graphical image on the client using the preloaded graphical instructions and a combined set of preloaded graphical data and graphical data streamed from the server.

5. The method according to claim 1, wherein the image is comprised of a plurality of tiles and wherein preloaded graphical data includes a collection of perceptually dissimilar tiles stored separately that each visually approximates a distinct subset of the plurality of tiles from a source image that has been identified as being perceptually similar.

6. The method according to claim 5, further comprising rendering the image using a plurality of perceptually dissimilar tiles, the plurality of perceptually dissimilar tiles being less than or equal to the plurality of tiles, and wherein tile similarity is identified by combining multi-scale error calculations and a Sobel gradient approximation comparison.

7. The method according to claim 1, further comprising interpreting a shared video memory on the client device in a mode dependent manner.

8. The method according to claim 7, further comprising updating the shared video memory via a wireless link to the server.

9. The method according to claim 1, wherein the preloaded instructions are firmware.

10. The method according to claim 1, further comprising loading the preloaded graphical instructions into the client device prior to instantiation of an associated application on the server, at instantiation of the application on the server, and/or during runtime of the application on the server.

11. The method according to claim 1, further comprising transmitting the preloaded graphical data wirelessly to the client device and storing the preloaded graphical data on the client device for subsequent use.

12. The method according to claim 1, further comprising transmitting the preloaded graphical instructions wirelessly to the client device and storing the preloaded graphical instructions on the client device for subsequent execution based on a command from the server.

13. The method according to claim 1, further comprising loading the preloaded graphical data into the client device prior to instantiation of an associated set of instructions running on the server, at instantiation of the set of instructions running on the server, and/or during runtime of the set of instructions running on the server.

14. The method according to claim 1, further comprising replacing an unused portion of the preloaded graphical data by the server during execution of the instruction.

15. The method according to claim 1, further comprising replacing an unused portion of the preloaded graphical instructions by the server during execution the instruction.

16. The method according to claim 1, further comprising harmonizing by the server the image on the client device with a logical model of the image on the server, wherein harmonizing includes maintaining by the server a model of the image on the client, comparing effects of one or more graphical updates requested by a application running on the server and sending appropriate graphical updates to the client device to cause the image to match the requested graphical updates.

17. The method according to claim 1, further comprising rendering the image on the client device based on preloaded graphical data and/or preloaded graphical instructions while additional graphical data and/or additional graphical instructions are wirelessly transmitted from the server to the client device to supplement or replace graphical data or graphical instructions on the client device during a runtime environment.

18. The method according to claim 17, wherein an amount of additional graphical data and/or additional graphical instructions transmitted to the client device is minimized based on the preloaded graphical data and/or preloaded graphical instructions and requirements of the runtime environment on the server and the client device.

19. The method according to claim 1, wherein the instruction includes a wireless command to the client device to execute the one or more preloaded graphical instructions.

20. The method according to claim 19, wherein the wireless command includes a plurality of directives to the client device to execute a plurality of the one or more preloaded graphical instructions.

21. The method according to claim 1, wherein preloaded graphical instructions use preloaded graphical data and streaming graphical data from the server.

22. The method according to claim 1, further comprising passing to the client device one or more parameters triggering rendering of at least a portion of the preloaded graphical data.

23. The method according to claim 22, wherein the one or more parameters identify the portion of preloaded graphical data to use for rendering of the portion of the preloaded graphical data.

24. The method according to claim 1, further comprising tracking and/or verifying by the server the preloaded graphical data and/or the one or more preloaded graphical instructions stored on the client device.

25. The method according to claim 24, wherein responsive to determining that one or more portions of preloaded graphical data or preloaded graphical instructions required by a set of instructions running on the server are absent from the client device, loading on the client device required but absent portions of the preloaded graphical data and/or required or absent portions of the one or more preloaded graphical instructions.

26. The method according to claim 1, further comprising initiating by a single command by the server a particular sequence of preloaded graphical instructions on the client device.

27. The method according to claim 1, further comprising transmitting by the server to the client device a graphical code fragment to supplement preloaded graphical instructions on the client device.

28. The method according to claim 1, responsive to the image rendered on the client device, further comprising replacing the preloaded graphical instructions and/or preloaded graphical data using a change instruction by the server.

29. A system for rendering graphical images on wireless thin clients, comprising:
a graphics engine embedded on a client device wherein the graphics engine includes preloaded graphical data and one or more preloaded graphical instructions; and
at least one library located on a server in communication with an application programming interface wherein at least one library includes an instruction executable by a machine resident on the server to wirelessly control rendering of an image on the client device based on the preloaded graphical data and/or the one or more preloaded graphical instructions.

30. The system according to claim 29, wherein the preloaded graphical instructions can operate on the preloaded graphical data to generate a graphical image on the client.

31. The system according to claim 29, wherein the preloaded graphical instructions can operate on graphical data streamed from the server to generate a graphical image on the client.

32. The system according to claim 29, wherein the preloaded graphical instructions can operate on a combined set of preloaded graphical data and graphical data streamed from the server to generate a graphical image on the client.

33. The system according to claim 29, wherein preloaded graphical data includes perceptually dissimilar tiles stored separately and wherein each dissimilar tile visually approximates a distinct subset of tiles from a source image that has been identified as being perceptually similar.

34. The system according to claim 29, wherein the image is comprised of a plurality of tiles and wherein preloaded graphical data includes a collection of perceptually dissimilar tiles stored separately that visually approximates a distinct subset of the plurality of tiles that has been identified as being perceptually similar.

35. The system according to claim 34, wherein the image is rendered using a plurality of perceptually dissimilar tiles, the plurality of perceptually dissimilar tiles being less than or equal to the plurality of tiles, and wherein tile similarity is identified by combining multi-scale error calculations and a Sobel gradient approximation comparison.

36. The system according to claim 29, wherein the client device includes a shared video memory that is interpreted in a mode dependent manner.

37. The system according to claim 36, wherein the shared video memory can be updated via a wireless link to the server.

38. The system according to claim 29, wherein the preloaded instructions are firmware.

39. The system according to claim 29, wherein the preloaded instructions are loaded into the client device prior to instantiation of an associated application on the server, at instantiation of an application on the server, and/or during runtime of the application on the server.

40. The system according to claim 29, wherein the preloaded graphical data is wirelessly transmitted to the client device and stored on the client device for subsequent use.

41. The system according to claim 29, wherein the preloaded graphical instructions are wirelessly transmitted to the client device and stored on the client device for subsequent execution based on a command from the server.

42. The system according to claim 29, wherein the preloaded graphical data is loaded into the client device prior to instantiation of an associated application on the server, at instantiation of an application on the server, and/or during runtime of the application on the server.

43. The system according to claim 29, wherein an unused portion of the preloaded graphical data is replaced by the server during execution of the instruction.

44. The system according to claim 29, wherein an unused portion of the preloaded graphical instructions are replaced by the server during execution of the instruction.

45. The system according to claim 29, wherein the server collects a representation of one or more recent graphical updates requested by an application running on the server and thereafter compares the representation of one or more graphical updates and a logical model of the image on the client device and harmonizes the image on the client device with recent graphical updates by transmitting appropriate graphical updates to the client device.

46. The system according to claim 29, wherein images can be rendered on the client device based on preloaded graphical data and/or preloaded graphical instructions while additional graphical data and/or additional graphical instructions are wirelessly transmitted from the server to the client device based on images displayed on the client device during a runtime environment.

47. The system according to claim 29, wherein the instruction includes a wireless command to the client device to execute the one or more preloaded graphical instructions.

48. The system according to claim 47, wherein the wireless command includes a plurality of directives to the client device to execute a plurality of the one or more preloaded graphical instructions.

49. The system according to claim 29, wherein preloaded graphical instructions use preloaded graphical data and streaming graphical data from the server.

50. The system according to claim 29, wherein the instruction passes one or more parameters to the client device triggering rendering of at least a portion of the preloaded graphical data.

51. The system according to claim 29, wherein the one or more parameters identify the portion of preloaded graphical data to use for rendering of the portion of the preloaded graphical data.

52. The system according to claim 29, wherein the server is operable to track and/or verify preloaded graphical data and preloaded graphical instructions stored on the client device.

53. The system according to claim 52, wherein responsive to server determining that one or more portions of preloaded graphical data or preloaded graphical instructions required by an application are absent from the client device, the at least one library located on a server includes another instruction to load on the client device required but absent portions of preloaded graphical data and/or required but absent portions of preloaded graphical instructions.

54. The system according to claim 29, wherein the instruction can initiate by a single command a particular sequence of preloaded graphical instructions on the client device.

55. The system according to claim 29, wherein the server can transmit to the client device a graphical code fragment to supplement preloaded graphical instructions on the client device.

56. A computer-readable storage medium tangibly embodying a program of instructions executable by a machine wherein said program of instruction comprises a plurality of program codes for controlling, by a server, rendering of an image on a client device, said program of instruction comprising:
program code for loading on the client device preloaded graphical data and/or one or more preloaded graphical instructions;
program code for controlling the rendering the image on the client device by directing, by the client device, execution of the one or more preloaded instructions and/or use of the preloaded graphical data.

57. The computer-readable storage medium of claim 56 wherein the program of instruction further comprises program code for generating the image on the client device using the one or more preloaded graphical instructions and/or the preloaded graphical data.

58. The computer-readable storage medium of claim 56 wherein the program of instruction further comprises program code for combining, at the client device, the preloaded graphical data with graphical data streamed from the server to render the image.

59. The computer-readable storage medium of claim 56 wherein the image comprises a plurality of tiles and wherein the program of instruction further comprises program code to identify from the plurality of tiles a distinct subset of the plurality tiles as being perceptually similar.

60. The computer-readable storage medium of claim 59 wherein the program of instruction further comprises program code to render the image on the client device using a plurality of dissimilar tiles, the plurality of dissimilar tiles being less than or equal to the plurality of tiles.

61. The computer-readable storage medium of claim 60 wherein the program of instruction further comprises program code to store separately on the client as preloaded graphical data the plurality of dissimilar tiles.

62. The computer-readable storage medium of claim 56 wherein the program of instructions further comprises program code to load the preloaded graphical data and/or the one or more preloaded graphical instructions prior to instantiation of an associated application on the server, at instantiation of the application on the server, and/or during runtime of the application on the server.

63. The computer-readable storage medium of claim 62 wherein the program of instruction further comprises program code to wirelessly transmit to and store on the client device the preloaded graphical data and the one or more preloaded graphical instructions.

64. The computer-readable storage medium of claim 63 wherein the program of instruction further comprises program code to supplement the preloaded graphical data and/or the one or more preloaded graphical instructions during runtime of an associated application on the server.

65. The computer-readable storage medium of claim 56 wherein the program of instruction further comprises program code to track and verify status of the preloaded graphical data and the one or more preloaded graphical instructions stored on the client device.

66. The computer-readable storage medium of claim 65 wherein the program of instruction, responsive to determining that one or more portions of the preloaded graphical data and/or one or more portions of the one or more preloaded graphical instructions required by an application are absent from the client device, further comprises program code to load on the client device required but absent portions of preloaded graphical data and/or required or absent portions of the one or more preloaded graphical instructions.
